(19) United States
(12) Patent Application Publication
(10) Pub. No.: US 2010/0057253 A1
(43) Pub. Date: Mar. 4, 2010

(54) Robot and method of controlling safety thereof

(75) Inventors: Sung Gu Kwon, Suwon (KR); Young Do Kwon, Yongin-si (KR); Dong Hun Lee, Ansan-si (KR); Won Kuk Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/385,888

(22) Filed: Apr. 22, 2009

(30) Foreign Application Priority Data
Sep. 4, 2008 (KR) 10-2008-87362

(51) Int. Cl. G06F 19/00

(52) U.S. Cl. 700/245

(57) ABSTRACT

Disclosed are a robot, which performs biped walking similar to a human being, and a method of controlling safety of the robot. When the robot falls down, an air bag located in the falling direction is operated and the posture of the robot is changed into an attention posture. When the robot secondarily falls down after the falling of the robot, an air bag located in the secondary falling direction is operated to minimize damage to the elements of the robot due to the secondary falling of the robot.

### CROSS-REFERENCE TO RELATED APPLICATIONS

This application claims the benefit of Korean Patent Application No. 2008-0087362, filed on Sep. 4, 2008, in the Korean Intellectual Property Office, the disclosure of which is incorporated herein by reference.

### BACKGROUND

1. Field

The present invention relates to a robot, which performs biped walking similar to a human being and minimizes damage when the robot falls down, and a method of controlling safety of the robot.

2. Description of the Related Art

In general, machines, which conduct motions similar to those of a human being using an electrical or mechanical action, are referred to as robots. Early robots were industrial robots, such as manipulators or transfer robots for automation and unmanned operation in a production site. Recently, a walking robot, which has a similar joint system to that of a human being and which easily walks with two feet in a human working and living space, has been researched and developed.

The walking of a biped walking robot is carried out by the following process. When walking instructions, such as walking speed, walking direction, step width, etc., are given, the biped robot determines target positions and directions of both feet (right and left), and generates position and direction trajectories of both feet according to time based on the above determination. At this time, a target ZMP (zero moment point; a point where the sum total of the moments of the robot against the ground equals zero) trajectory is determined by the positions of both feet of the robot. That is, using a principle that the robot does not fall down when the ZMP is located in the polygonal surface formed by the supporting of one foot or two feet when the robot walks, a target ZMP is set such that the robot can stably walk. A walking pattern is generated such that the ZMP of the robot (the point where the moment of the robot against the ground equals zero) equals the target ZMP, and walking trajectories of both feet are generated based on the walking pattern. Thus the robot can perform the biped walking similar to that of a human being.

Since the above biped walking robot performs biped walking in the same manner as a human being, the robot loses its balance and leans due to the tilting of the bottom of the foot contacting the ground when the biped walking robot walks on an uneven surface or a surface having obstacles. The robot may also fall due to various causes, such as an external impact or an error in the walking pattern, even during normal walking.

### SUMMARY

Therefore, one aspect of the exemplary embodiment is to provide a biped walking robot, which allows an air bag in the falling direction to be operated. Also, the robot is changed into an attention posture when the robot falls down during walking, to minimize damage to elements of the robot due to falling. This also secures a user's safety. It is another aspect to provide a method of controlling safety of the robot.

Additional aspects and/or advantages will be set forth in part in the description which follows and, in part, will be apparent from the description, or may be learned by practice of the invention.

The foregoing and/or other aspects of the present exemplary embodiment is achieved by providing a robot comprising, a torso, a plurality of legs connected to the torso, the robot waling by a motion of the legs; a sensing unit to sense a falling of the robot; a plurality of air bags; and a control unit to change a posture of the robot and operate one of the air bags located in a falling direction of the robot, when the falling of the robot is sensed.

The sensing unit may be an acceleration sensor, which is installed on a portion of the robot that moves less that the legs, and the sensing unit senses the falling of the robot according to an acceleration of the torso.

The one of the air bags is installed at a portion of the robot that first contacts the ground during the falling of the robot.

The robot may further include a posture changing unit which is controlled by the control unit, wherein the posture changing unit changes the posture of the robot into an attention posture prior to or simultaneously with the operation of the air bag.

The control unit may sense the falling direction of the robot by the sensing unit, and a respective one of the air bags corresponding to the falling direction of the robot.

The control unit may determine whether or not the robot secondarily falls down after the falling of the robot, and operate one of the air bags in a secondary falling direction of the robot when it is determined that the robot secondarily falls down.

The robot may further include an alarm unit to inform a user of the falling of the robot, and the control unit may monitor whether or not the robot stands on the legs after the falling of the robot, and control the alarm unit such that the alarm unit informs of the falling of the robot when the robot does not stand on the legs.

The robot may further include a power cutoff unit to interrupt power supplied to the robot, and the control unit may monitor whether or not the robot stands on the legs after the falling of the robot, and control the power cutoff unit such that the power cutoff unit interrupts the power supplied to the robot when the robot cannot stand on the legs.

The foregoing and/or other aspects of the present exemplary embodiment may be achieved by providing a method of controlling a robot, including sensing a falling of the robot, the robot walking by legs connected to a torso; changing a posture of the robot, when the falling of the robot is sensed; and operating a corresponding air bag out of a plurality of bags according to a falling direction of the robot.

The sensing the falling of the robot may include sensing variations of accelerations with an acceleration sensor installed at a portion of the robot that moves less than the legs during the walking.

The method may further include changing the posture to an attention posture if the falling is sensed.

The changing of the posture of the robot may be prior to or simultaneously with the operating of the air bag.

The method may further include determining whether or not the robot secondarily falls down after the falling of the robot; and checking a secondary falling direction of the robot and operating an air bag out of the plurality of air bags corresponding to the secondary falling direction, when the robot secondarily falls down.

The method may further include monitoring whether or not the robot stands on the legs after the falling of the robot; and informing a user of the falling of the robot, when the robot cannot stand on the legs.

The method may further include monitoring whether or not the robot stands on the legs after the falling of the robot; and cutting off power supplied to the robot or converting the mode of the robot into a standby mode, when the robot cannot stand on the legs.

### BRIEF DESCRIPTION OF THE DRAWINGS

These and/or other aspects of the exemplary embodiment will become apparent and more readily appreciated from the following description of the embodiment, taken in conjunction with the accompanying drawings in which:

FIG. 1 is a schematic view illustrating the external appearance of a robot in accordance with an exemplary embodiment;

FIG. 2 is a view illustrating principal joint structures of the robot of FIG. 1;

FIG. 3 is a block diagram illustrating a safety control system of the robot of FIG. 1;

FIG. 4 is a flow chart illustrating a method of controlling safety of the robot of FIG. 1;

FIG. 5 is a view illustrating a posture of the robot of FIG. 1 and the air bag operating state thereof, when the robot falls forward;

FIG. 6 is a view illustrating a posture of the robot of FIG. 1and the air bag operating state thereof, when the robot falls backward;

FIG. 7 is a view illustrating a posture of the robot of FIG. 1 and the air bag operating state thereof, when the robot falls to the left; and

FIG. 8 is a view illustrating a posture of the robot of FIG. 1 and the air bag operating state, when the robot falls to the right.

### DETAILED DESCRIPTION OF EMBODIMENT

Reference will now be made in detail to the exemplary embodiment which is illustrated in the accompanying drawings, wherein like reference numerals refer to like elements throughout. The embodiment is described below to explain the present invention by referring to the annexed drawings.

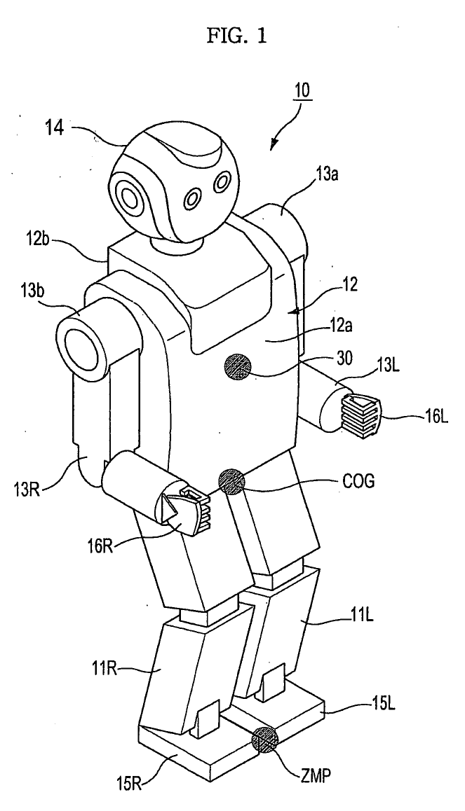

FIG. 1 is a schematic view illustrating the external appearance of a robot in accordance with the exemplary embodiment.

As shown in FIG. 1, a robot 10 is a biped walking robot, which walks erectly with two legs 11R and 11L in the same manner as a human being. The robot 10 includes a torso 12, two arms 13R and 13L and a head 14 connected to the upper portion of the torso 12. The robot 10 also includes feet 15R and 15L and hands 16R and 16L respectively connected to front ends of two legs 11R and 11L and the two arms 13R and 13L. Here, R represents the right side of the robot 10, L represents the left side of the robot 10, COG represents the center of gravity of the robot 10, and ZMP represents a point where the total inertia force, i.e., the sum total of the moment in the roll direction (in the direction of the X-axis, i.e., the direction of the walking of the robot) and the moment in the pitch direction (in the direction of the Y-axis, i.e., the direction of the step width of the robot) on the contact surface of the robot 10 with the ground, equals zero.

A 3-axis acceleration sensor (hereinafter, referred to as an acceleration sensor) 30 to sense the falling the robot 10 and the falling direction of the robot 10 is installed in the central portion of the torso 12. The torso 12, in which the acceleration sensor 30 is installed, moves relatively little compared with other portions of the robot 10, and variations of the accelerations of the torso 12 are gradually increased or decreased in a normal state. However, when the robot 10 falls down or overturns due to an unexpected situation, acceleration values of the torso 12 on the X-axis, Y-axis, and Z-axis are rapidly changed in positive (+) or negative (−) directions. The acceleration sensor 30 senses changes of the acceleration values on the 3 axes, and thus senses the falling of the robot 10 and the falling direction of the robot 10. The acceleration sensor 30 is widely applied to actual air bag systems for vehicles, and the installation position of the acceleration sensor 30 is not limited to the torso 20 but the acceleration sensor 30 may be installed on any portions of the robot 10, which move relatively little.

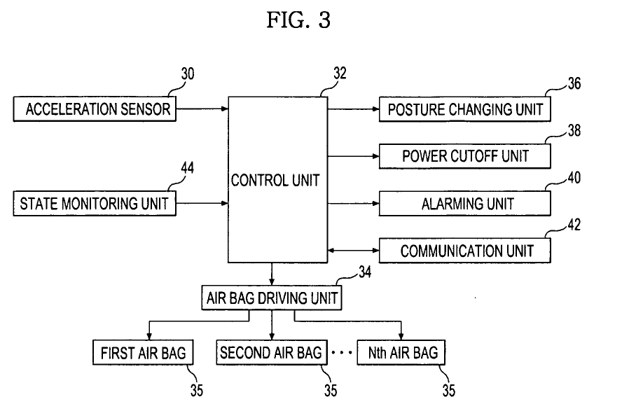

Further, air bags 35 (with reference to FIG. 3) are respectively installed on a breast 12a on the front surface of the torso 12, a back 12b on the rear surface of the torso 12, and right and left shoulders 13a and 13b. When the robot 10 falls down, the breast 12a, the back 12b, and the right and left shoulders 13a and 13b, on which the air bags 35 are installed, first contact the surface of the ground, and thus are most highly damaged. The installation positions of the air bags 35 are not limited to the breast 12a, the back 12b, and the right and left shoulders 13a and 13b, but the air bags 35 may be installed to surround the entire robot 10 to secure the safety of the robot 10 and user's safety. However, the air bags 35 in the minimum number need to be installed at positions to exhibit the maximum effect on account of the installation and management problems.

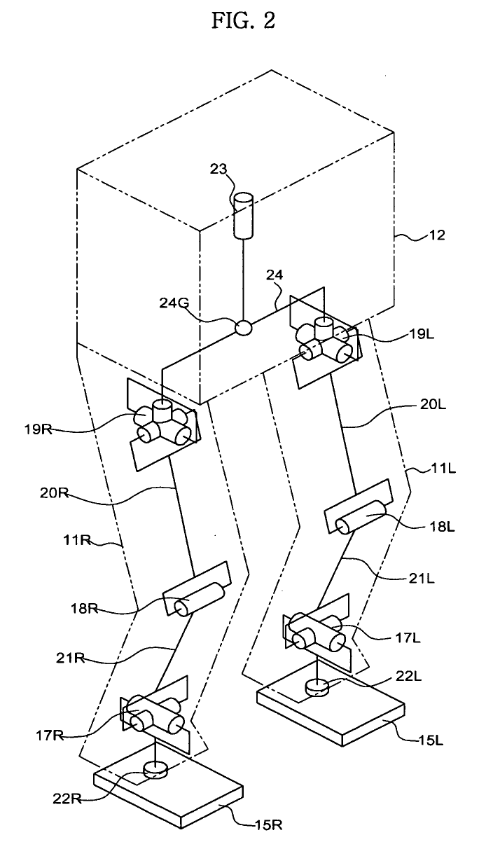

FIG. 2 is a view illustrating principal joint structures of the robot of FIG. 1.

As shown in FIG. 2, the two legs 11R and 11L respectively include ankle joints 17R and 17L, knee joints 18R and 18L, and hip joints 19R and 19L such that portions of the robot 10 corresponding to ankles, knees, and hips can rotate. The hip joints 19R and 19L are located at both side ends of the lower portion of the torso 12 connected to the two legs 11R and 11L.

The ankle joints 17R and 17L of the legs 11R and 11L can move in the directions of the X-axis and the Y-axis. The knee joints 18R and 18L can move in the direction of the Y-axis, and the hip joints 19R and 19L can move in the directions of the X-axis, the Y-axis, and the Z-axis (in the direction of a yaw axis).

Further, the two legs 11R and 11L respectively include upper links 20R and 20L connecting the hip joints 19R and 19L and the knee joints 18R and 18L, and lower links 21R and 21L connecting the knee joints 18R and 18L and the ankle joints 17R and 17L, such that the robot 10 can walk with a designated degree of freedom according to the movement of the respective joints 17R and 17L, 18R and 18L, and 19R and 19L. Force and torque sensors (hereinafter, referred to as F/T sensors) 22R and 22L, which are respectively installed on ankles of the legs 11R and 11L, measure three direction components (Mx, My, Mz) of a moment and three direction components (Fx, Fy, Fz) of a force transmitted from the feet 15R and 15L, and provides ZMP data.

The torso 12 connected with the two legs 11R and 11L includes a wrist joint 23 such that a portion of the robot 10 corresponding to a wrist can rotate. The wrist joint 23 is located coaxially with a central position 24G of a hip link 24 connecting the hip joints 19R and 19L located at both side ends of the lower portion of the torso 12.

Although not shown in the drawings, each of the joints 17R and 17L, 18R and 18L, 19R and 19L, and 23 of the robot 10 includes an actuator for the operation thereof (for example, an electric driving device, such as a motor).

FIG. 3 is a block diagram illustrating a safety control system of the robot in accordance with the exemplary embodiment. The safety control system of the robot 10 includes the acceleration sensor 30, a control unit 32, an air bag driving unit 34, a posture changing unit 36, a power cutoff unit 38, an alarm unit 40, a communication unit 42, and a state monitoring unit 44.

The control unit 32 determines whether or not the robot 10 falls down by comparing variations of 3 axis acceleration values, sensed by the acceleration sensor 30, with a predetermined value, checks the falling direction of the robot 10, when the robot 10 is about to fall down, and operates the air bag 35 installed in the falling direction of the robot 10 (for example, installed at the breast, the back, or the right or left shoulder). The control unit 32 thus minimizes damage to devices of the robot 10 due to the falling of the robot 10, securing user's safety as well as the safety of other articles around the robot 10.

Further, the control unit 32 determines whether or not the robot 10 secondarily falls down due to the center of gravity of the robot 10 after the falling of the robot 10, and operates the air bag 35 installed in the secondary falling direction of the robot 10 when the robot 10 secondarily falls down (for example, when the robot 10 falls again forward or backward due to the weight of the robot 10 after the robot 10 falls forward or backward). Thus the user's safety is secured as well as the safety of the robot 10 due to the secondary falling of the robot 10.

Further, the control unit 32 changes the posture of the robot 10 into a predetermined attention posture prior to or simultaneously with the operation of the air bag 35 when the robot 10 is about to fall down. Thus the control unit 32 maximally reduces damage to devices of the robot 10 due to the operation of the air bag 35. When the robot 10 falls down during walking, the portion of robot 10 first contacting the surface of the ground is varied according to the posture assumed by the robot 10. For example, when the joint of the arm 13R or 13L of the robot is bent and thus the elbow first contacts the surface of the ground, although the air bag 35 in the falling direction of the robot 10 is operated, the operation of the air bag 35 is ineffective. Therefore, the posture of the robot 10 needs to be changed to the attention posture so as to minimize damage to devices of the robot 10 due to the operation of the air bag 35.

Further, the control unit 32 monitors whether or not the robot 10 stands on its own legs after the falling of the robot 10, and allows follow-up measures to be taken after the standing when the robot 10 can stand on its own legs. The control unit 32 also informs a user of the falling of the robot 10 and converts the mode of the robot 10 into a standby mode or an end mode when the robot 10 cannot stand on its own legs, thus reducing unnecessary power consumption and causing rapid follow-up measures to be taken.

The air bag driving unit 34 operates the air bag 35 located in the falling direction of the robot 10, among the plurality of the air bags 35 installed on the breast 12a, the back 12b, and the right and left shoulders 13a and 13b, according to a driving control signal of the control unit 32, when the robot 10 is about to fall down.

The posture changing unit 36 changes the posture of the robot 10 into the attention posture prior to or simultaneously with the operation of the air bag 35 according to a posture control signal of the control unit 32, when the robot 10 is about to fall down.

The power cutoff unit 38 cuts off power supplied to the robot 10 or converts the mode of the robot 10 into the standby mode according to a power control signal of the control unit 32, when the robot 10 cannot stand on its own legs after the falling of the robot 10.

The alarm unit 40 generates a voice, an LED light, or a warning sound to inform a user of the falling of the robot 10 according to an alarm control signal of the control unit 32, when the robot 10 cannot stand on its own legs after the falling of the robot 10.

The communication unit 42 transmits the falling of the robot 10 to an external user through a network, such as a wireless internet (WiFi, B/T, Zigbee, etc.) or a wireless telephone network (2G, 3G, etc.) according to a communication control signal of the control unit 32 such that the external user can be aware of the falling of the robot 10, when the robot 10 cannot stand on its own legs after the falling of the robot 10.

The state monitoring unit 44 monitors the state of the robot 10 through various sensors (a three-dimensional measuring instrument, the F/T sensor, etc.) installed on the robot 10 and transmits the monitored state of the robot 10 to the control unit 32, in order to determine whether or not the robot 10 stands on its own legs after the falling of the robot 10.

Hereinafter, the operation and functions of the above robot and a method of controlling safety of the robot will be described.

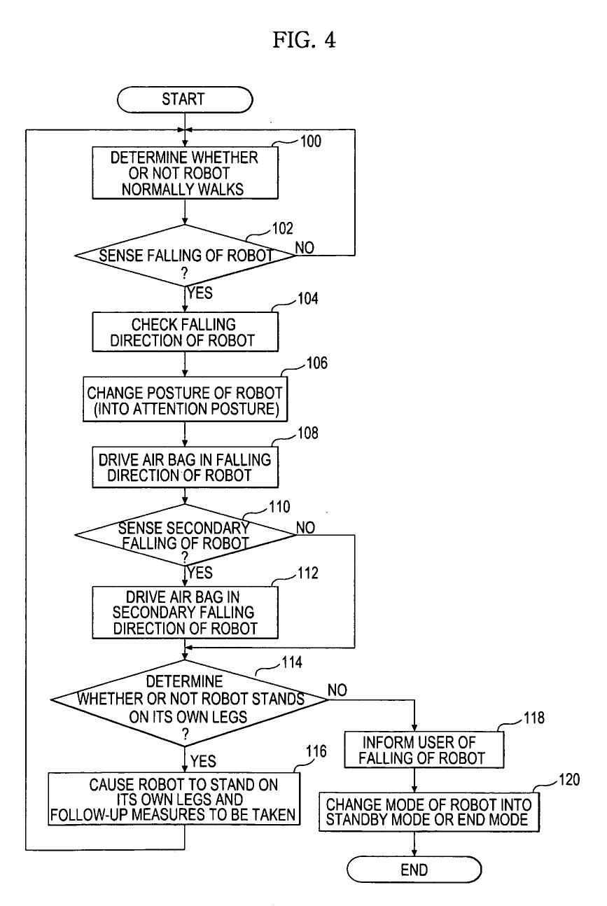

FIG. 4 is a flow chart illustrating a method of controlling safety of a robot in accordance with the embodiment of the present invention.

In FIG. 4, when walking instructions, such as a walking speed, a walking direction, a step width, etc., are given, the control unit 32 generates a pattern of the COG satisfying the ZMP equation between the COG and the ZMP to determine target positions and directions of both feet 15R and 15L and generate a walking pattern forming position and direction trajectories of both feet 15R and 15L according to time based on the determined target positions and direction of both feet 15R and 15L.

Through ZMP-based walking control using a principle that the robot 10 does not fall down when the ZMP is located in the support polygon of the robot 10, a walking pattern satisfying the ZMP equation is generated while controlling the posture of the robot 10 such the ZMP is maintained in the support polygon.

Therefore, the robot 10 walks according to the generated walking pattern. Since the 3 axis acceleration values, sensed by the acceleration sensor 30 installed on the central portion of the torso 12 of the robot 10, are gradually increased or decreased when the robot 10 normally walks, the control unit 32 receives variations of the 3 axis acceleration values, sensed by the acceleration sensor 30, and determines that the robot 10 normally walks (operation 100).

However, when the robot 10 walks on an uneven surface of the ground or a surface of the ground having obstacles, the robot 10 loses its balance due to the tilting of the bottom of the foot contacting the ground. Further, when the robot 10 is about to fall due to an unexpected situation, such as an external impact or an error in the walking pattern, during normal walking, the 3 axis acceleration values sensed by the acceleration sensor 30 are rapidly changed in positive (+) or negative (−) directions.

Therefore, the control unit 32 receives variations of the 3 axis acceleration values, sensed by the acceleration sensor 30, through the acceleration sensor 30, senses whether or not the robot 10 is about to fall down by comparing the received variations to a predetermined value (operation 102). The control unit 32 checks the falling direction of the robot 10 when the robot 10 is about to fall down (operation 104).

Thereafter, when the robot 10 falls down, the control unit 32 transmits the posture control signal to the posture changing unit 36 such that the posture of the robot 10 is changed to a predetermined attention posture, and the posture changing unit 36 changes the posture of the robot 10 to the attention posture according to the posture control signal of the control unit 32 (operation 106). Here, the posture of the robot 10 is changed to the attention posture prior to or simultaneously with the operation of the air bag 35 in the falling direction of the robot 10, and thus damage to devices of the robot 10 due to the operation of the air bag 35 is maximally reduced. The portion of robot 10 first contacting the surface of the ground is varied according to the posture assumed by the robot 10 when the robot 10 falls down during walking. For example, when the joint of the arm 13R or 13L of the robot is bent and thus the elbow first contacts the surface of the ground, although the air bag 35 in the falling direction of the robot 10 is operated, the operation of the air bag 35 is ineffective. Therefore, the posture of the robot 10 needs to be changed to the attention posture so as to minimize damage to devices of the robot 10 due to the operation of the air bag 35.

Thereafter, the control unit 32 transmits the driving control signal to the air bag driving unit 34 such that the air bag 35 installed in the falling direction of the robot 10 (for example, installed at the breast, the back, or the right or left shoulder) is operated simultaneously with the posture change of the robot 10 into the attention posture, and the air bag driving unit 34 operates the air bag 35 installed in the falling direction of the robot 10 among the air bags 35 installed at the breast 12a, the back 12b, and the right and left shoulders 13a and 13b according to the driving control signal (operation 108).

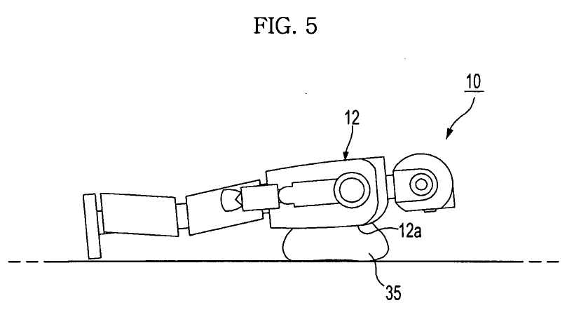

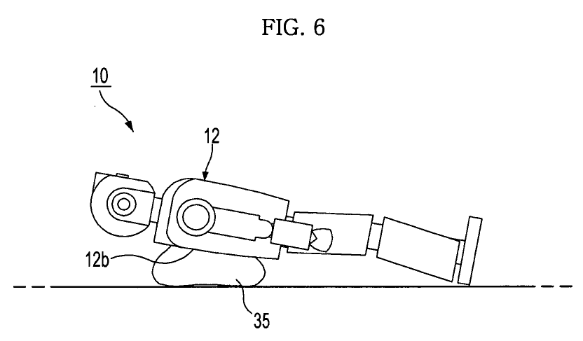

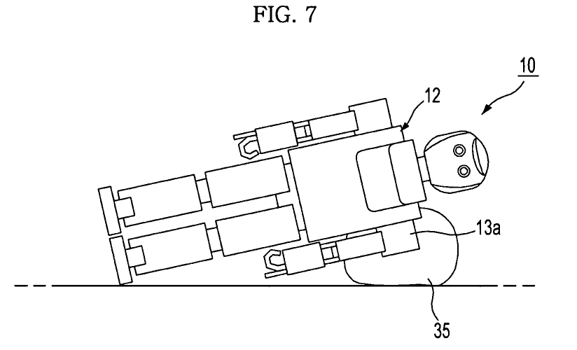

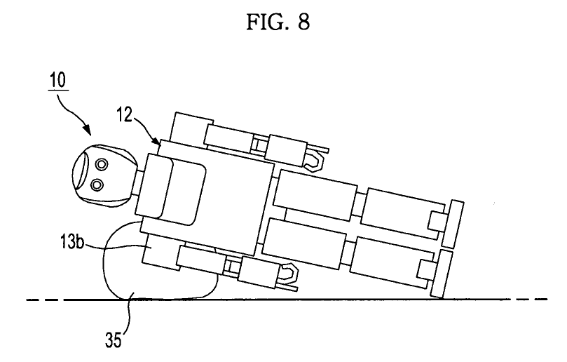

FIG. 5 is a view illustrating a posture of the robot in accordance with the exemplary embodiment of the present invention and its air bag operating state, when the robot falls forward, FIG. 6 is a view illustrating a posture of the robot in accordance with the exemplary embodiment and its air bag operating state, when the robot falls backward. FIG. 7 is a view illustrating a posture of the robot in accordance with the exemplary embodiment and its air bag operating state, when the robot falls to the left, and FIG. 8 is a view illustrating a posture of the robot in accordance with the exemplary embodiment and its air bag operating state, when the robot falls to the right.

As shown in FIGS. 5 to 8, any one of the air bags 35 installed on the breast 12a, the back 12b, and the right and left shoulders 13a and 13b, which will first contact the surface of the ground and be heavily damaged when the robot 10 falls down, is operated, thus minimizing damage to devices of the robot 10 due to the falling of the robot 10, and securing user's safety as well as the safety of other articles around the robot 10. At this time, the robot 10 maintains a predetermined attention posture such that the operation of any one of the air bags 35 can be maximized.

Thereafter, the control unit 32 determines whether or not the robot 10 secondarily falls down due to the center of gravity of the robot 10 after the falling of the robot 10 (operation 110). As shown in FIGS. 7 and 8, when the robot 10 falls to the left or right, the robot 10 may fall forward or backward again due to the center of gravity of the robot 10. Thus, operation 110 serves to secure the safety of the robot 10 when the robot 10 secondarily falls down.

As a result of the determination of operation 110, when the robot 10 secondarily falls down, the control unit 32 checks the secondary falling direction of the robot 10 and operates the air bag 35 located in the secondary falling direction of the robot 10 (operation 112), thus maximally securing user's safety and the safety of the robot 10 under any condition due to the falling of the robot 10.

After the falling of the robot 10, the state monitoring unit 44 monitors the state of the robot 10, i.e., whether or not the robot 10 stands on its own legs, through various sensors (a three-dimensional measuring instrument, the F/T sensor, etc.) installed on the robot 10 and transmits the monitored state of the robot 10 to the control unit 32 (operation 114).

Therefore, the control unit 32 controls the robot 10 such that the robot 10 can stand for itself and take follow-up measures, when the robot 10 stands on its own legs (operation 116).

As a result of the monitoring of operation 114, when the robot 10 cannot stand on its own legs, the control unit 32 transmits the alarm control signal to the alarm unit 40, and the alarm unit 40 generates a voice, an LED light, or a warning sound according to the alarm control signal of the control unit 32 to inform a user of the falling state of the robot 10 and allow follow-up measures to be rapidly taken (operation 118).

On the other hand, when a user is located at the outside, the falling state of the robot 10 is transmitted to the user at the outside through the communication unit 42 to allow follow-up measures to be rapidly taken.

Thereafter, the control unit 32 transmits the power control signal to the power cutoff unit 38 to reduce unnecessary power consumption, and the power cutoff unit 38 cuts off power supplied to the robot 10 or converts the mode of the robot 10 into a standby mode according to the power control signal of the control unit 32 (operation 120).

As a result of the determination of operation 110, when the robot 10 does not secondarily fall down, operation 114 is carried out.

As described above, when the robot performing biped walking similar to a human being falls down, an air bag located in the falling direction is operated and the posture of the robot is changed into an attention posture to minimize damage to devices of the robot due to the falling of the robot and secure user's safety. When the robot secondarily falls down after the falling of the robot (for example, the robot falls again forward or backward due to the weight of the robot after the robot falls down to the left or right), an air bag located in the secondary falling direction is operated to minimize damage to the elements of the robot due to the secondary falling of the robot.

Further, whether or not the robot stands on its own legs after the falling of the robot is monitored, and the robot allows follow-up measures to be taken after the standing when the robot can stand on its own legs, and informs a user of the falling of the robot and converts the mode of the robot into a standby mode when the robot cannot stand on its own legs, thus reducing unnecessary power consumption and causing rapid follow-up measures to be taken.

Although an exemplary embodiment has been shown and described, it would be appreciated by those skilled in the art that changes may be made in this embodiment without departing from the principles and spirit of the invention, the scope of which is defined in the claims and their equivalents.

What is claimed is:

1. A robot, comprising:
a torso;
a plurality of legs connected to the torso, the robot walking by a motion of the legs;
a sensing unit to sense a falling of the robot;
a plurality of air bags; and
a control unit to change a posture of the robot and operate one of the air bags located in a falling direction of the robot, when the falling of the robot is sensed.

2. The robot according to claim 1, wherein the sensing unit is an acceleration sensor, which is installed on a portion of the robot that moves less than the legs and the sensing unit senses the falling of the robot according to an acceleration of the torso.

3. The robot according to claim 1, wherein the operated one of the air bags is installed at a portion of the robot that first contacts the ground during the falling of the robot.

4. The robot according to claim 1, further comprising a posture changing unit which is controlled by the control unit,
wherein the posture changing unit changes the posture of the robot into an attention posture prior to or simultaneously with the operation of the air bag.

5. The robot according to claim 1, wherein the control unit senses the falling direction of the robot by the sensing unit, and a respective one of the air bags corresponding to the falling direction of the robot.

6. The robot according to claim 1, wherein the control unit determines whether or not the robot secondarily falls down after the falling of the robot, and operates one of the air bags corresponding to a secondary falling direction of the robot when it is determined that the robot secondarily falls down.

7. The robot according to claim 1, further comprising an alarm unit to inform a user of the falling of the robot,
wherein the control unit monitors whether or not the robot stands on the legs after the falling of the robot, and controls the alarm unit such that the alarm unit informs of the falling of the robot when the robot does not stand on the legs.

8. The robot according to claim 1, further comprising a power cutoff unit to interrupt power supplied to the robot,
wherein the control unit monitors whether or not the robot stands on the legs after the falling of the robot, and controls the power cutoff unit such that the power cutoff unit interrupts the power supplied to the robot when the robot cannot stand on the legs.

9. A method of controlling a robot, the robot walking by legs connected to a torso, the method comprising:
sensing a falling of the robot, which walks by legs connected to a torso;
changing a posture of the robot, when the falling of the robot is sensed; and
operating a corresponding air bag out of a plurality of bags according to a falling direction of the robot.

10. The method according to claim 9, wherein the sensing the falling of the robot comprises sensing variations of accelerations with an acceleration sensor installed at a portion of the robot, that moves less than the legs during the walking.

11. The method according to claim 9, further comprising changing the posture to an attention posture if the falling is sensed.

12. The method according to claim 11, wherein the changing of the posture of the robot is achieved prior to or simultaneously with the operating of the air bag.

13. The method according to claim 9, wherein the operating of the corresponding air bag comprises checking a falling direction of the robot operating the air bag corresponding to the falling direction.

14. The method according to claim 9, further comprising:
determining whether or not the robot secondarily falls down after the falling of the robot; and
checking a secondary falling direction of the robot and operating an air bag out of the plurality of air bags corresponding to the secondary falling direction, when the robot secondarily falls down.

15. The method according to claim 9, further comprising:
monitoring whether or not the robot stands on the own legs after the falling of the robot; and
informing a user of the falling of the robot, when the robot cannot stand on the own legs.

16. The method according to claim 9, further comprising:
monitoring whether or not the robot stands on the legs after the falling of the robot; and
cutting off power supplied to the robot or converting the mode of the robot into a standby mode, when the robot cannot stand on the own legs.
